(19) United States
(12) Patent Application Publication
(10) Pub. No.: US 2020/0016481 A1
(43) Pub. Date: Jan. 16, 2020

(54) ENCAPSULATED ILLUMINATED DIE

(71) Applicant: George James Stathakis, Sedalia, CO (US)

(72) Inventor: George James Stathakis, Sedalia, CO (US)

(21) Appl. No.: 16/508,810

(22) Filed: Jul. 11, 2019

Related U.S. Application Data
(60) Provisional application No. 62/696,575, filed on Jul. 11, 2018.

(51) Int. Cl. A63F 9/24; H02J 7/02; H01F 38/14; F21V 23/04; A63F 9/04

(52) U.S. Cl. CPC A63F 9/24; H02J 7/025; H01F 38/14; A63F 9/0413; A63F 9/0415; A63F 2009/2454; A63F 2009/2494; F21V 23/0471

(57) ABSTRACT

An illuminated game piece, such as a die or dice in which an electrical circuit powering a light source are encapsulated by a material forming a body of the game piece. The electrical circuit includes an inductive charging coil, an energy storage device and at least one illumination device. The inductive charging coil may be coupled to an inductive charger to replenish the energy storage device. When encapsulated, there are no ports or external connectors and the integrity of the game piece is assured so that is no change in game play.

### CROSS-REFERENCE TO RELATED APPLICATION

This application claims the benefit of priority of U.S. provisional application No. 62/696,575, filed Jul. 11, 2018, the contents of which are herein incorporated by reference.

### BACKGROUND OF THE INVENTION

The present invention relates to game pieces, such as dice, and, more particularly, to lighted game pieces for game play.

For some games lighted game pieces may be utilized to add entertainment value to the game. For others that are played at night or in areas of limited illumination, a lighted game piece allows the game to be played in these environments.

Currently, other solutions for illuminating game pieces include plugs, ports, connections or other exterior item that inhibit play. Likewise, other illuminated game pieces do not perform as the original games piece was designed to perform.

Typical illuminated game pieces in the art are of a two part construction that provides a housing and an access panel or port. A power source for one or more lighting elements are carried within the interior housing. The access panel permits assembly of the interior components and for replenishment one or more of the power source or to change a bulb of the lighting element, should either become inoperative.

While these game pieces may be suitable for certain game play environments and games, providing access to the interior compartment of the housing may be undesirable. For example, in the case of a die or dice, game play depends upon each of the die being balanced to provide the desired randomness of a roll of the dice. Access to the interior compartment may be exploited by unscrupulous players so that their die or dice may produce a more advantageous roll.

In other instances, two part game pieces of this type may be limited to indoor use or use in environments with limited moisture. When used outdoors or in high moisture environments, the internal components are susceptible to moisture infiltration. This can lead to premature corrosion of the internal components or otherwise render the game piece illumination inoperative.

As can be seen, there is a need for an improved game piece that solves the foregoing deficiencies in illuminated game pieces.

### SUMMARY OF THE INVENTION

In one aspect of the present invention, an illuminated die for game play is disclosed. The die includes a body formed as a geometric solid by an encapsulating material to sealingly contain an electrical illumination circuit. The electrical illuminating circuit includes an inductive charging coil oriented subjacent to an outer face of the body. An energy storage device is carried within the body and configured to store an electrical charge from the inductive charging coil. One or more light sources are carried within the body. The one or more light sources are operatively connected to the energy storage device for illumination by an electrical charge of the energy storage device.

In some embodiments, the illuminated die may also include control electronics to selectively illuminate the one or more light sources. The control electronics may include a motion activated switch. The control electronics may also include a timer configured to extinguish the one or more light sources after a predetermined temporal period.

In preferred embodiments, each of the inductive charging coil, the energy storage device, and the control electronics are encapsulated by the encapsulating material forming a solid body.

In some embodiments, the encapsulating material may be a translucent material. In other embodiments, the encapsulating material is a transparent material.

In other aspects of the invention, an illuminated game piece, is disclosed. The game piece includes: an inductive charging coil; an energy storage device configured to store an electrical charge from the inductive charging coil; one or more light sources operatively connected to the energy storage device for illumination by an electrical charge of the energy storage device, and a body formed of an encapsulating material to surround each of the inductive charging coil, the energy storage device, and the one or more light sources.

In some embodiments, the game piece may also include control electronics to selectively illuminate the one or more light sources. The control electronics may include a motion activated switch. In other embodiments, the control electronics include a timer configured to extinguish the one or more light sources after a predetermined temporal period.

In preferred embodiments, the coil is positioned immediately subjacent to an external face of the body. The coil may be shaped to conform to the external face of the body.

The encapsulating material is selected from a transparent or a translucent material.

These and other features, aspects and advantages of the present invention will become better understood with reference to the following drawings, description and claims.

### BRIEF DESCRIPTION OF THE DRAWINGS

FIG. 1 is a perspective view of a pair of dice;

FIG. 2 is a top perspective view of the invention, with internal components shown in dashed lines;

FIG. 3 is a bottom perspective view of the invention, with internal components shown in dashed lines;

FIG. 4 is a side view of the invention, with internal components shown in dashed lines;

FIG. 5 is a section view of the invention, taken along line 5-5 in FIG. 2; and

FIG. 6 is a schematic view of the electrical components.

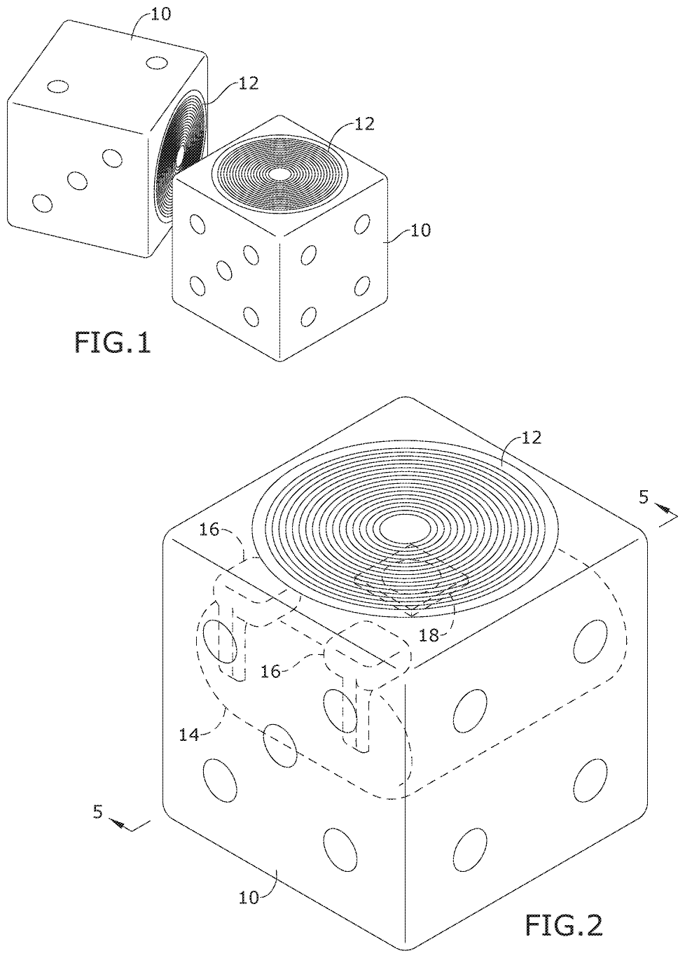

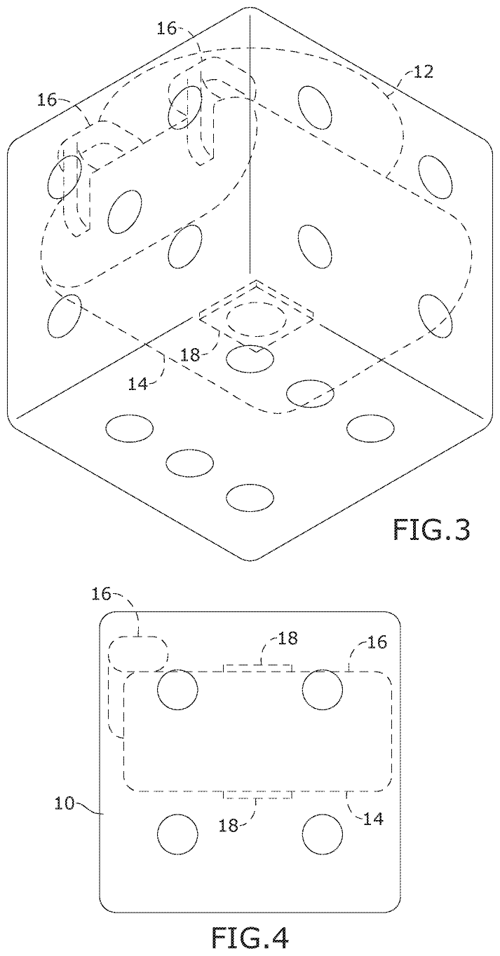

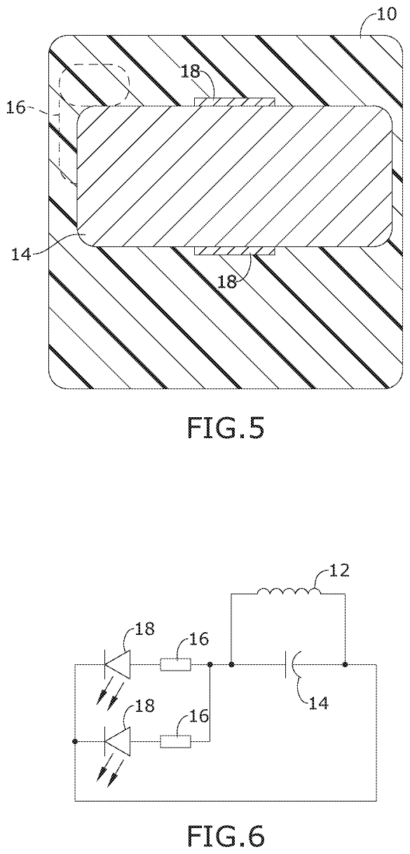

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an improved illuminated game piece in which the illumination components are encapsulated within the game piece to protect against moisture infiltration and discourage alteration or adulteration of the game piece.

In the non-limiting embodiments shown in the drawings, a game piece, such as a die, or pair of dice are shown. The die has a body 10 and internal electrical components that are encapsulated within the exterior body 10. In this case, the die may be a six sided cube, typical for a conventional die. In other die embodiments, the body may be octahedral, or any desired shape.

The electrical components may include an inductive charging coil 12 oriented subjacent to an outer face of the body 10. An energy storage device 14 is carried within the body 10. The energy storage device 14 may include a rechargeable battery, or preferably a capacitor. Control electronics 16 are provided to selectively control illumination of one or more light sources 18, such as a light emitting diode (LED), by the energy storage device. The electrical components may be interconnected by one or more conductors or may be carried on a circuit board.

The control electronics 16 may include a motion activated switch to illuminate the light source 18 when the body is moved. Likewise, the control electronics 16 may include a timer to extinguish the one or more light sources 18 when the body 10 has been at rest for a predetermined temporal period. The control electronics 16 may also be configured so that the one or more light sources 18 continuously illuminate or illuminate in a flashing sequence.

The charging coil 12 is configured to inductively charge the energy storage device 14 via an inductive charger that is separate from the die. Placement of the charging coil 12 proximal to the inductive charger generates an electric charge to replenish the energy storage device 14 before, and if necessary, during play of the game. In the embodiment shown, the charging coil 12 is formed as a flattened spiral to conform with a face of the body 10. In other embodiments, the charging coil may be spheroidal or other shape that conforms to an outer surface of the body 10.

In preferred embodiments, the electrical components are completely encapsulated in the material from which the body 10 is formed. In this configuration, with the exception of the conductors, the electrical components may be physically separated within the body 10 of the die. The body 10 may be formed of any suitable material such as a thermoplastic material, a resin, an epoxy, or a polymeric or a rubberized material, depending upon a desired action for the body 10 to exhibit during game play. In some embodiments, the body 10 may be transparent. In other embodiments, the body 10 may be formed of a translucent material sufficient to pass light from the light source 14 to illuminate the body 10.

The electrical components that make up the game piece can be assembled directly together via the conductors or individually placed on a printed circuit board (PCB) that interconnects the elements. The assembled electrical components can be encapsulated within the body by means of a suitable mold or form. The encapsulating material selected game piece characteristics are injected in the mold to encapsulate the electrical components. With the encapsulation of the electrical components within the body, the electrical components are hermetically sealed from exposure to the external environment, thereby providing a long lasting durable game piece.

If the game piece requires specific weight distribution, care should be taken to properly assemble and place the electrical components such that game piece performance is maintained within allowable parameters. Charging performance is maximized by assembling the game piece with the induction charging coil 12 immediately subjacent to a face of the body 10 to increase coupled voltage with the inductive charging unit.

It should be understood, of course, that the foregoing relates to exemplary embodiments of the invention and that modifications may be made without departing from the spirit and scope of the invention as set forth in the following claims.

What is claimed is:

1. An illuminated die for game play comprising:
a body formed as a geometric solid by an encapsulating material to sealingly contain an electrical illumination circuit, the electrical illuminating circuit comprising;
an inductive charging coil oriented subjacent to an outer face of the body;
an energy storage device carried within the body and configured to store an electrical charge from the inductive charging coil; and
one or more light sources carried within the body, the one or more light sources operatively connected to the energy storage device for illumination by the electrical charge of the energy storage device.

2. The illuminated die of claim 1, further comprising:
control electronics to selectively illuminate the one or more light sources.

3. The illuminated die of claim 2, wherein the control electronics include a motion activated switch.

4. The illuminated die of claim 2, wherein the control electronics include a timer configured to extinguish the one or more light sources after a predetermined temporal period.

5. The illuminated die of claim 2, wherein each of the inductive charging coil, the energy storage device, and the control electronics are encapsulated by the encapsulating material forming a solid body.

6. The illuminated die of claim 5, wherein the encapsulating material is a translucent material.

7. The illuminated die of claim 5, wherein the encapsulating material is a transparent material.

8. An illuminated game piece, comprising:
an inductive charging coil;
an energy storage device configured to store an electrical charge from the inductive charging coil;
one or more light sources operatively connected to the energy storage device for illumination by an electrical charge of the energy storage device; and
a body formed of an encapsulating material to surround each of the inductive charging coil, the energy storage device, and the one or more light sources.

9. The illuminated game piece of claim 8, further comprising:
control electronics to selectively illuminate the one or more light sources.

10. The illuminated die of claim 9, wherein the control electronics include a motion activated switch.

11. The illuminated die of claim 9, wherein the control electronics include a timer configured to extinguish the one or more light sources after a predetermined temporal period.

12. The illuminated die of claim 9, wherein the coil is positioned immediately subjacent to an external face of the body.

13. The illuminated game piece of claim 10, wherein the coil is shaped to conform to the external face of the body.

14. The illuminated game piece of claim 13, wherein the encapsulating material is selected from a transparent or a translucent material.
